(19) United States
(12) Patent Application Publication
(10) Pub. No.: US 2009/0228366 A1
(43) Pub. Date: Sep. 10, 2009

(54) Linking Method For Affiliate Programs

(75) Inventors: Ioan Biris, Burnaby (CA); Horacio Arevalo, New Westminster (CA)

Correspondence Address: LOWE HAUPTMAN HAM & BERNER, LLP, 1700 DIAGONAL ROAD, SUITE 300, ALEXANDRIA, VA, 22314, US

(73) Assignee: CEM SOLUTIONS PRIVATE LIMITED, Burnaby (CA)

(21) Appl. No.: 12/041,923

(22) Filed: Mar. 4, 2008

(51) Int. Cl. G06Q 30/00

(52) U.S. Cl. 705/26

(57) ABSTRACT

The present invention relates to a web-based method for linking websites using an affiliate program through an affiliate program server, said method comprising acts of linking a referral URL(s) to an affiliate account, where the URL(s) is submitted by affiliate or merchant and approved by the merchant; clicking product(s) and/or service(s) on an affiliate website by user; redirecting the user to a suitable merchant website based on his selection of the product (s) and/or service(s); retaining the referral URL in web browser cookie for the redirected user and sending the referral URL to the affiliate program server to credit click, if the referral URL is linked to an unique affiliate account; and pushing the referral URL from the cookie to the affiliate program server by the merchant website as the user transacted by ordering the product (s) and/or service (s) and thereafter applying commission by the affiliate program, if the referral URL is linked to the unique affiliate account.

### TECHNICAL FIELD OF THE INVENTION

The present invention relates to a novel kind of linking between affiliate website and merchant website. The invention preferably relates to a linking method for an affiliate program.

### BACKGROUND OF THE INVENTION

The Internet enables vast and immediate interconnectedness through the use of a common software structure, generated and read via computer code known as hypertext markup language or “HTML.” Access to information and movement around the web is enhanced through the use of hyperlinks (“links”) within a web page's HTML. The link, manifest as a word in a text field or an image on a web page, acts as a path, moving a user from one web page address, known as a Uniform Resource Locator (URL), to another web page address.

The movement from one URL to another allows near-instant access to information, products, and services and is particularly well-suited to the exchange of information, goods, and services between buyers (“users”) and sellers (“Merchants”). Such business is commonly referred to as “e-commerce,” or “electronic commerce.”

With the abundance of goods and services available, a problem arises in efficiently connecting an interested user with the appropriate information pertaining to the desired goods and/or services. A Merchant therefore must make known, or advertise, its URL in order to reach those users on the Internet that are interested in the goods and/or services offered. Hypertext links lend themselves to an active (rather than static) advertisement since they actually provide the user with a path or entry point to the Merchant's URL. Then, once at the Merchant's URL, the user can initiate a transaction.

By advertising through the use of hyperlinked banner images and/or text links, a Merchant may increase its sales by increasing the number of users (commonly referred to as “traffic”) that visit their URL, and potentially increase transactions. To this end, the Merchant must determine how and where on the Internet to advertise in order to maximize traffic that fits the Merchant's targeted market. In contrast to traditional static advertising, hyperlinked active advertising provides the opportunity to chart a transaction from inception to end, beginning with the initial movement from advertisement to Merchant URL, using link with a uniqueid for each affiliate member and ending with the user's completed transaction.

Most Merchants currently utilize some form of affiliate system to increase sales, track traffic using any of the known tracking mechanisms for example an unique identifier attached to the affiliate account provided by the merchant, and compensate Webmasters for referrals of traffic and/or transactions. Webmasters are the content providers of the Internet, who maintain URLs in order to disperse information and links to other URLs. These links are often in the form of a Merchant's advertisement, such as a banner ad and/or text links. In these systems, the Webmaster usually directs the traffic to the Merchants via predetermined selection and placement of Merchant's links. The Webmasters are then generally compensated according to a given scale or interval, based on the sale.

The tracking mechanism allows the Merchant to apply commission and/or to credit clicks to the affiliate. Further, the tracking mechanism allows the Merchant to determine advertising compensation based on sale. Such a system, which relies on a uniqueid tracking mechanism, is commonly referred to as an affiliate program.

The growing popularity of affiliate programs among both Webmasters and Merchants has led to a wide array of resources addressing affiliate commerce. Such resources include search engines, directories, and compilations of Webmaster feedback relating exclusively to affiliate program.

The affiliate receives an unique identifier from the Merchant's affiliate program such as www.aaa.com/?keyword=(uniqueid). The affiliate uses that unique identifier as part of its linkage system (dynamic URL), to make the merchant site to track of who sent the traffic and/or transaction to apply the proper action such as a click or a sale commission.

All affiliate software use dynamic linkage or parameterized links. It looks like this www.aaa.com/?keyword=(uniqueid). The problem in those affiliate software is that Search Engines and Google especially rank a page (in search results) based on how many outside pages are linking to that particular website/page. Affiliate programs seem to help because they link affiliate to web pages, but Search Engines have decided that links using dynamic parameters are in fact paid links and they are discarded from the links count.

### BRIEF SUMMARY OF THE INVENTION

Accordingly, it is an important embodiment of the present invention to provide a web-based method of linking websites using an affiliate program through an affiliate program server, said method comprising acts of linking a referral URL(s) to an affiliate account, where the URL(s) is submitted by affiliate or merchant and approved by the merchant; clicking product(s) and/or service(s) on an affiliate website by user; redirecting the user to a suitable merchant website based on his selection of the product (s) and/or service(s); retaining the referral URL in web browser cookie for the redirected user and sending the referral URL to the affiliate program server to credit click, if the referral URL is linked to an unique affiliate account; and pushing the referral URL from the cookie to the affiliate program server by the merchant website as the user transacted by ordering the product (s) and/or service (s) and thereafter applying commission by the affiliate program, if the referral URL is linked to the unique affiliate account.

It is another important an embodiment of the present invention to provide a new way of linking a URL to an affiliate account.

It is another important embodiment of the present invention to provide a program of instructions executable by a computer to perform a web-based method of linking websites using an affiliate program through an affiliate program server, said program comprises acts of linking a referral URL(s) to an affiliate account, where the URL(s) is submitted by affiliate or merchant and approved by the merchant; clicking product(s) and/or service(s) on an affiliate website by user; redirecting the user to a suitable merchant website based on his selection of the product (s) and/or service(s); retaining the referral URL in web browser cookie for the redirected user and sending the referral URL to the affiliate program server to credit click, if the referral URL is linked to an unique affiliate account; and pushing the referral URL from the cookie to the affiliate program server by the merchant website as the user transacted by ordering the product (s) and/or service (s) and thereafter applying commission by the affiliate program, if the referral URL is linked to the unique affiliate account.

### BRIEF DESCRIPTION OF THE DRAWINGS

The preferred embodiments of the invention will hereinafter be described in conjunction with the appended drawings provided to illustrate and not to limit the invention, in which

FIG. 1 shows flow chart explaining sequence of steps involved in the invention.

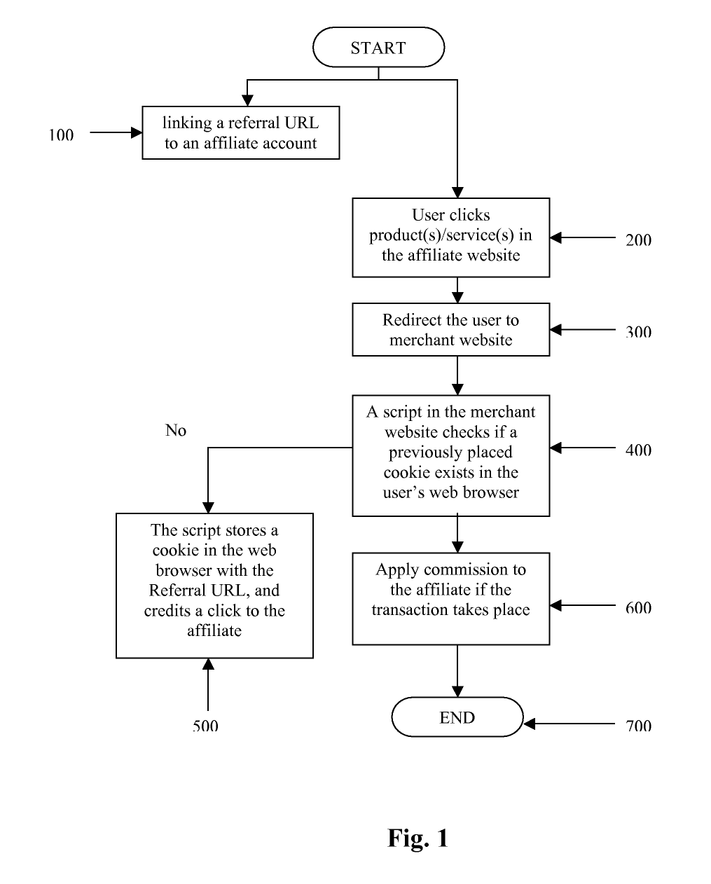

### DETAILED DESCRIPTION OF THE PREFERRED EMBODIMENTS

The primary embodiment of the present invention is a web-based method of linking websites using an affiliate program through an affiliate program server said method comprising acts of linking a referral URL(s) to an affiliate account, where the URL(s) is submitted by affiliate or merchant and approved by the merchant; clicking product(s) and/or service(s) on an affiliate website by user; redirecting the user to a suitable merchant website based on his selection of the product (s) and/or service(s); retaining the referral URL in web browser cookie for the redirected user and sending the referral URL to the affiliate program server to credit click, if the referral URL is linked to an unique affiliate account; and pushing the referral URL from the cookie to the affiliate program server by the merchant website as the user transacted by ordering the product (s) and/or service (s) and thereafter applying commission by the affiliate program, if the referral URL is linked to the unique affiliate account.

In yet another embodiment of the present invention the method provides a link between the affiliate website and the merchant website.

In still another embodiment of the present invention the affiliate member's account has a approved URL(s) linked to his unique ID.

In still another embodiment of the present invention the user is a web browser or a customer.

In still another embodiment of the present invention the transaction details comprises product details, total sale amount, user details and other related predefined details.

Another important embodiment of the present invention is a program of instructions executable by a computer to perform a web-based method for linking websites using an affiliate program through an affiliate program server, said program comprises acts of linking a referral URL(s) to an affiliate account, where the URL(s) is submitted by affiliate or merchant and approved by the merchant; clicking product(s) and/or service(s) on an affiliate website by user; redirecting the user to a suitable merchant website based on his selection of the product (s) and/or service(s); retaining the referral URL in web browser cookie for the redirected user and sending the referral URL to the affiliate program server to credit click, if the referral URL is linked to an unique affiliate account; and pushing the referral URL from the cookie to the affiliate program server by the merchant website as the user transacted by ordering the product (s) and/or service (s) and thereafter applying commission by the affiliate program, if the referral URL is linked to the unique affiliate account.

An affiliate program is a way of linking a website to an affiliate account. This enables the merchant to give a percentage (%) or fixed amount of those sales to the referring website.

Every web browser has referral URL information ready to be sent to the server as per the request.

This invention enables a new kind of linking between affiliate website and merchant website. Instead of using dynamic linkage (www.aaa.com?keyword=(uniqueID) the present invention proposes linking using www.aaa.com. Instead of having cookies with unique ID installed by the dynamic script, the present invention is using the script installing cookies with referral URL by the script that will be used to link the sales/click to an unique affiliate ID, if the URL was approved by merchant to any unique affiliate ID.

In order to do this, each affiliate accounts can have URL(s) approved and linked to them. Wherein the URL(s) is submitted by affiliate or merchant and approved by the merchant for each unique affiliate account. Once a web browser arrives on merchant website a script checks for cookies. If none is present, a script stores the referring URL in a cookie and the same script pushes the referral URL to affiliate program server. If the affiliate program server finds that referral URL was approved for an affiliate account then it will credit the affiliate with a click. If not it gets discarded.

Once a web browser arrives at post order page, the information from the cookies is pushed to the affiliate program server by the merchant website. If the cookies have URL information (not necessary) then the affiliate program will check to see if the URL was linked to an affiliate account and applies the commission. If not the information gets discarded.

The method of linking in the present invention is the actual URL of the merchant and as such the links will be indexed by Search Engines and will be counted. They will increase the page rank.

In this example, there is going to be three parties involved: “Customer” (User), “Affiliate” and “Merchant”.

The user is the end client using a Web Browser, looking to buy certain product or service.

The affiliate is the party that attracts users and redirects him/her to the merchant to generate the sale.

The merchant is the party that makes the sale, bill the user, supplies the user with the desired product or service and handles the user support and pays a commission based on the sale to the affiliate.

The process flow explained below will establish a web-link between affiliate website and merchant website through affiliate program, in which

Step 1 (200): linking a referral URL to an affiliate account, where the URL is submitted by affiliate or merchant and approved by the merchant.

Step 2 (300) the user arrives to the Affiliate web site and browses the product (s) and/or service(s).

Step 2 (400): the user selects a product and he/she is sent to the Merchant website from the Affiliate website.

Step 3 (500): when the user arrives to the Merchant website, a script in the merchant website checks if a previously placed cookie exists in the user's web browser. If no cookie present in the web browser, then the script stores a cookie in the web browser with the Referral URL and credits a click to the affiliate.

Step 4 (600): the user orders from the Merchant website, the sale amount along with referral URL is sent to the Affiliate program for processing, which will try to link the Referral URL to an Affiliate, and apply the proper commissions.

What is claimed is:

1. A web-based method of linking websites using affiliate program through an affiliate program server, said method comprising acts of;
i. linking a referral URL(s) to an affiliate account, where the URL(s) is submitted by affiliate or merchant and approved by the merchant;
ii. clicking product(s) and/or service(s) on an affiliate website by user;
iii. redirecting the user to a suitable merchant website based on his selection of the product (s) and/or service(s);
iv. retaining the referral URL in web browser cookie for the redirected user and sending the referral URL to the affiliate program server to credit click, if the referral URL is linked to an unique affiliate account; and
v. pushing the referral URL from the cookie to the affiliate program server by the merchant website as the user transacted by ordering the product (s) and/or service (s) and thereafter applying commission by the affiliate program, if the referral URL is linked to the unique affiliate account.

2. The method as claimed in claim 1, wherein the method provides link between the affiliate website and the merchant website.

3. The method as claimed in claim 1, wherein the affiliate member's account has a approved URL(s) linked to his unique ID.

4. The method as claimed in any of the previous claims, wherein the user is a web browser or a customer.

5. The method as claimed in claim 1, wherein the transaction details comprises product details, total sale amount, user details and other related predefined details.

6. A program of instructions executable by a computer to perform a web-based method of linking websites using affiliate program through an affiliate program server, comprises acts of linking a referral URL(s) to an affiliate account, where the URL(s) is submitted by affiliate or merchant and approved by the merchant; clicking product(s) and/or service(s) on an affiliate website by user; redirecting the user to a suitable merchant website based on his selection of the product(s) and/or service(s); retaining the referral URL in web browser cookie for the redirected user and sending the referral URL to the affiliate program server to credit click, if the referral URL is linked to an unique affiliate account; and pushing the referral URL from the cookie to the affiliate program server by the merchant website as the user transacted by ordering the product (s) and/or service (s) and thereafter applying commission by the affiliate program, if the referral URL is linked to the unique affiliate account.
